(19) United States
(12) Patent Application Publication
(10) Pub. No.: US 2025/0128302 A1
(43) Pub. Date: Apr. 24, 2025

(54) METHOD AND SYSTEM FOR DETERMINING THE END OF A CIP PHASE

(71) Applicant: Ecolab USA Inc., St. Paul, MN (US)

(72) Inventors: Matt Porter, West St. Paul, MN (US); Kyle Caldwell, Minneapolis, MN (US); Mark Malwitz, Lakeville, MN (US); Colby Bruggeman, St. Louis Park, MN (US); Stephan Scharrenbach, Krefeld (DE); Sandeep Chugh, Aurora, IL (US); Jonathan Vang, Savage, MN (US); Albert Goldfain, Chanhassen, MN (US); Pete Swenson, Cannon Falls, MN (US)

(21) Appl. No.: 18/920,613

(22) Filed: Oct. 18, 2024

Related U.S. Application Data
(60) Provisional application No. 63/591,337, filed on Oct. 18, 2023.

(51) Int. Cl. B08B 9/032; G01N 21/47; G01N 21/85

(52) U.S. Cl. CPC B08B 9/0325; G01N 21/4738; G01N 21/85; B08B 2209/032; G01N 2021/4769

(57) ABSTRACT

A method may involve directing a fluid through a fluid path that includes industrial equipment during a phase of a clean-in-place (CIP) process to remove soil from the industrial equipment. The method can include analyzing a turbidity of a bolus of fluid within the fluid path at a first time to provide a first measured turbidity of the bolus of the fluid and at a second time to provide a second measured turbidity of the bolus of the fluid. In some cases, the bolus of the fluid travels through the industrial equipment between the first time and the second time. The method can include determining an end of the phase of the CIP process based on the first measured turbidity and the second measured turbidity, and controlling the CIP process based upon the determined end of the phase.

### RELATED APPLICATION

This application claims priority to U.S. Provisional Application No. 63/591,337, filed Oct. 18, 2023, the entire contents of which are incorporated herein by reference.

### TECHNICAL FIELD

This disclosure relates to clean-in-place (CIP) technology and, more particularly, to systems and techniques for controlling CIP processes.

### BACKGROUND

A clean-in-place (CIP) process is a cleaning technique adapted to remove soils from the internal components of industrial equipment, such as processing tanks, fluid lines, pumps, valves, heat exchangers, and other pieces of equipment. A CIP cleaning process cleans the internal surfaces of these components, often without the need to dismantle any of the components for individual cleaning. Rather, the components can be cleaned by passing a cleaning solution through the components, for example following a fluid path normally traveled by a fluid processed on the equipment, to clean the components.

Because of its ease of use and effectiveness, CIP cleaning processes have found widespread applicability in many different industries, particularly those industries where hygiene and sterility are of particular importance. Example industries that use CIP cleaning processes include dairy, beverage, brewing, processed food preparation, pharmaceuticals, and cosmetics. In these and other industries, internal surfaces of processing equipment can become contaminated with soil during operation. To help ensure the operational efficiency of the processing equipment and to prevent soil buildup from contaminating product produced on the equipment, the processing equipment is periodically cleaned using a CIP process.

The number of cleaning phases performed during a CIP cleaning process can vary depending on the specific process being performed. At minimum, a cleaning solution is passed through the processing equipment before resuming normal processing. Any product subsequently passed through the equipment that becomes contaminated by cleaner residue can be discarded. More typically, a CIP cleaning process involves at least three phases. In the first phase, which may be referred to as a pre-flush or pre-rinse phase, a fluid such as fresh water is passed through the processing equipment to flush the system of soil (e.g., residual product in the equipment, product build-up on equipment internals). In the second phase, which may be referred to as a cleaning phase, a chemical solution is passed through the processing equipment to clean and sanitize the equipment. Finally, in the third phase, a rinse liquid such as fresh water is passed through the processing equipment to rinse any residual cleaning solution from the equipment.

CIP processes are often time controlled, wherein each phase is run for a predetermined amount of time before stopping that phase and moving onto a next phase or completing the overall CIP process.

### SUMMARY

Time controlled CIP processes may operate for a predefined period of time such that one or more phases of the CIP process runs longer than is necessary in order to accommodate a worst case scenario and to ensure that the phase has sufficient time to complete its prescribed task. However, this often leads to more time than necessary spent during one or more phases. For example, if an object to be cleaned during a CIP phase is sufficiently clean, continued running of the CIP phase can consume time and resources (e.g., chemistry used in the CIP phase, power to operate one or more system components such as pumps, valves, sensors, etc.) without providing needed benefit. Similarly, if chemistry used during a CIP phase is prematurely consumed, the effectiveness of continuing to flow CIP fluid through the system diminishes. Thus, in some cases, equipment to be cleaned during a CIP phase may reach a steady state in which little or no further cleaning will be accomplished during the CIP phase even as the phase continues.

In general, aspects of this disclosure relate to systems and methods for determining an end of a phase of a CIP processes using measurements associated with the fluid flowing through the system. For instance, some aspects of the disclosure are directed toward a method including directing a fluid through a fluid path including industrial equipment. Methods can include analyzing a turbidity of a bolus of the fluid within the fluid path at a first time to provide a first measured turbidity and analyzing the turbidity of the bolus of the fluid within the fluid path at a second time to provide a second measured turbidity, wherein the bolus of the fluid travels through the industrial equipment to be cleaned between the first time and the second time. In some examples, this can include analyzing a turbidity at the first time using a first turbidity sensor upstream from the equipment and analyzing a turbidity at the second time using a second turbidity sensor downstream from the equipment. In other examples, this can include analyzing a turbidity using a single sensor at multiple points in time wherein a bolus of fluid flow through the equipment after having its turbidity analyzed by the single sensor and then recirculates to the single sensor where its turbidity is analyzed at a second time after having flown through the equipment.

Analyzing the turbidity of a bolus of fluid before and after flowing through equipment to be cleaned can provide information regarding soils leaving the equipment. For example, increased turbidity of a bolus of fluid exiting the equipment compared to the bolus of the fluid entering the equipment suggests soil added to the fluid from the equipment increased the turbidity of the bolus of the fluid, and that the CIP phase is having an effect on the soil load of the equipment. On the other hand, if the turbidity of the bolus of the fluid is approximately the same before and after flowing through the equipment, then the equipment likely did not add a significant amount of soil to the fluid to increase the turbidity thereof. This can suggest that no substantive removal of soil is occurring, and efficacy of the phase of the CIP process may have reached an end.

Accordingly, in some examples, methods can include determining an end of the phase of the CIP process based on the first measured turbidity and the second measured turbidity. For instance, in some cases, the difference between the first and second measured turbidity being sufficiently small (e.g., below a predetermined threshold) may be used to determine the end of a phase of the CIP process.

Other uses of the first measure turbidity and second measured turbidity are possible. For example, to reduce false negatives of determining and end of a phase of a CIP process, time and/or count conditions can be implemented. For example, in some cases, if the determined difference between the first and second measured turbidity is below the predetermined threshold, a count of occurrences (e.g., consecutive occurrences) of such a difference being below the threshold can be incremented. In some such examples, if a running count (e.g., consecutive instances) of measured turbidity differences being below a predetermined threshold meets a predetermined streak threshold, the end of the phase of the CIP process is determined to have occurred. In some examples, if the measured turbidity difference is above the predetermined threshold, the running count resets to zero (e.g., in a consecutive count process). In other examples, if the measured turbidity difference is above the predetermined threshold, the running count decrements by one and the analysis continues (e.g., in a cumulative sum process).

Other ways of determining an end of a phase of a CIP process can include, for example, fitting turbidity data over time to a turbidity model or determining a rate of change of turbidity over time and comparing the rate of change to a rate of change threshold condition.

In general, analyzing turbidity of a fluid flowing through equipment to be cleaned at multiple points in time can be used to assess the impact of the equipment on the turbidity of the fluid and determine an end of a phase of a CIP process. In some examples, methods include controlling the CIP process based on the determined end of the phase of the CIP process. For example, a completed phase of the CIP process can be stopped, and a new phase of the CIP process can be initiated or the entire CIP process can be completed.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is an illustration of an example clean-in-place (CIP) system.

FIG. 2 is a block diagram of an example sensor that may be used in the CIP system of FIG. 1.

FIG. 3A is a high-level schematic diagram of a CIP system used for cleaning equipment.

FIG. 3B is a plot of example turbidity information from a supply line sensor and a return line sensor.

FIG. 3C is a plot of example turbidity information for the supply line sensor and the return line sensor where the turbidity information from the supply line sensor is temporally shifted.

FIG. 3D is an example calculated difference signal between turbidity information from the supply line sensor and from the return line sensor.

FIG. 3E is an example successive difference signal showing a difference between consecutive points of a difference signal.

FIG. 4 is an example process flow diagram that involves determining an end of a CIP phase using a difference analysis.

FIG. 5 shows an example analysis of a successive difference signal to determine an end of a phase of a CIP process has occurred.

FIG. 6A shows another high-level schematic diagram of a CIP system used for cleaning equipment.

FIG. 6B shows an example plot of a turbidity signal from a single turbidity sensor over time.

### DETAILED DESCRIPTION

The present disclosure is generally directed to systems, devices, and techniques for cleaning of industrial equipment using a clean-in-place (CIP) process. Initially during the process, a pre-rinse fluid is passed under pressure through the industrial equipment to flush the equipment of soil during a pre-rinse phase. After the pre-rinse phase, one or more cleaning phases may be performed in which a cleaning fluid containing chemistry (e.g., detergent, acid, alkaline) is passed under pressure through the industrial equipment to help remove solid from the equipment. After the cleaning phase, a rinse phase may be performed in which a rinse fluid is passed under pressure through the industrial equipment to help remove residual chemistry from the equipment. Independent of the phase, the term soil as used herein generally refers to the component or components intended to be cleaned from the industrial equipment during the CIP process. Soil may include residual product being flushed from the equipment, built-up product in the equipment (e.g., baked-on product), and/or contaminants in the equipment, among other types of soils.

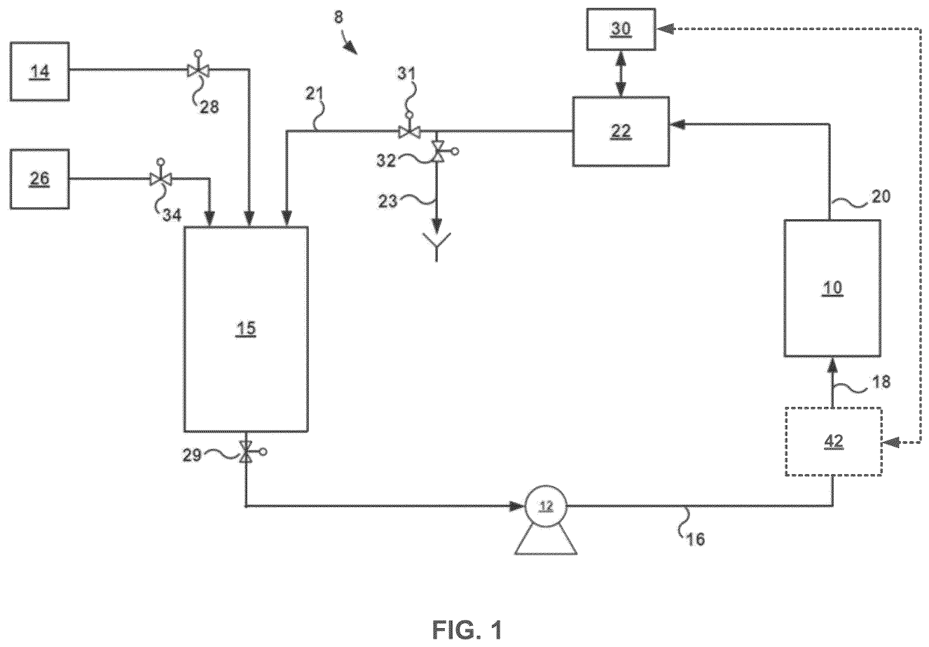

FIG. 1 is an illustration of an example CIP system 8 in which industrial equipment 10 is cleaned in place. System 8 includes a pump 12 fluidly connected to a source of pre-rinse fluid 14 via a tank 15. Tank 15 fills with pre-rinse fluid and provides a reservoir of fluid from which pump 12 can draw. Pump 12 draws pre-rinse fluid 14 at a suction side of the pump, pressurizes the fluid inside of the pump, and discharges the fluid at an elevated pressure into fluid conduit 16. Fluid conduit 16 is connected to a fluid inlet 18 of equipment 10 and conveys pressured fluid from the pump to the equipment. Inside of the industrial equipment 10, pre-rinse fluid 14 can flush soil from internal surfaces of the equipment so that pre-rinse fluid exiting fluid outlet 20 of the equipment contains soil. A sensor 22 receives pre-rinse fluid containing soil from fluid outlet 20 and analyzes the fluid, e.g., to determine a concentration of soil in the fluid. While shown in FIG. 1 as being positioned to receive fluid from fluid outlet 20, in some systems, one or more sensors (e.g., sensor 42 shown in dotted line) can be positioned upstream of fluid inlet 18 of equipment 10 such that the sensor receives fluid and then the fluid travels from the sensor to the fluid inlet 18 of equipment 10. Various systems can include such sensors upstream, downstream, or both upstream and downstream of equipment 10.

In some examples, receiving the fluid by a sensor (e.g., 22, 42) can comprise physically receiving the fluid into a housing of sensor. In other examples, receiving the fluid can include receiving fluid to within a proximity of the sensor such that the sensor can obtain information regarding the fluid even if the fluid does not physically engage the sensor. In some examples, sensor 22 and/or sensor 42 comprises a turbidity sensor configured to analyze a turbidity of the fluid. Fluid exiting industrial equipment 10 during a CIP process can either be returned to tank 15 via conduit 21 for recirculation or be disposed of to drain via a conduit 23.

CIP system 8 in FIG. 1 also includes a source of concentrated cleaning and/or sanitizing chemical 26 that is fluidly connected to tank 15. During a cleaning phase of the CIP process following the pre-rinse phase, the concentrated chemical may be dispensed into tank 15. In examples in which pre-rinse fluid 14 is water, the water source may also be fluidly connected to tank 15 to introduce water into the tank for generating a dilute chemical fluid from concentrated chemical 26. In operation, pump 12 can draw liquid cleaning fluid from tank 15, pressurize the fluid, and convey the cleaning fluid through industrial equipment 10. Typically, the cleaning fluid containing cleaning and/or sanitizing agent is recirculated through industrial equipment 10 via conduit 21 for a period of time or a number of recirculation cycles before being disposed of to drain via conduit 23.

CIP system 8 also includes an assortment of valves (28, 29, 31, 32, 34) and fluid conduits that control fluid movement through the system. A controller 30 manages the overall operation of CIP system 8. Controller 30 may be communicatively coupled to various components within CIP system 8, for example via a wired or wireless connection, so as to send and receive electronic control signals and information between controller 30 and the communicatively coupled components. For example, controller 30 may electronically actuate valves (28, 29, 31, 32, 34) to open/close the valves and control pump 12 to control fluid movement through the system. Controller 30 can also control one or more sensors (e.g., 22, 42) to analyze fluid entering and/or exiting equipment 10 and to determine a level of soil therein.

Although FIG. 1 illustrates one particular arrangement of a CIP system, is should be understood that this is only one example. The disclosure is not limited to a CIP system having any particular configuration, much less the particular configuration of FIG. 1. In different examples, CIP system 8 may not include tank 15 or may include multiple tanks, e.g., where one tank holds pre-rinse and/or rinse fluid and a separate tank holds cleaning fluid. As another example, CIP system 8 may include a heat exchanger, heater, and/or cooler to adjust the temperature of fluids used during the CIP cleaning process. CIP system 8 can include additional or different features, as will be appreciated by those of ordinary skill in the art.

Industrial equipment 10 may at various times during a CIP cleaning process be flushed with pre-rinse fluid, cleaning fluid, and rinse fluid. Pre-rinse fluid may be a fluid that functions to rinse soil from within industrial equipment 10, helping to eliminate soil residues within the equipment and prepare the equipment for subsequent flushing with a cleaning fluid. Pre-rinse fluid is typically water (e.g., may consist or consist essentially of water), although other suitable pre-rinse fluids may be used depending on the application. When pre-rinse fluid is water, the water may be supplied as fresh water from a pressurized water main or may be reused from a different process at the location of industrial equipment 10 (e.g., condenser water). In some examples, pre-rinse fluid is passed through industrial equipment 10 only a single time before being discarded to drain via conduit 23. In other examples, the pre-rinse fluid is recirculated through CIP system 8 via conduit 21 so the fluid passes through tank 15, pump 12, and industrial equipment 10 multiple times. During each successive pass through the industrial equipment, the pre-rinse fluid may release more soil from the industrial equipment. Recirculating pre-rinse fluid through industrial equipment 10 can help conserve the amount of fluid consumed during the pre-rinse process. Independent of whether the pre-rinse fluid is recirculated through industrial equipment 10 or passed through the equipment only a single time, the fluid may be discarded to drain at the end of the pre-flushing phase.

Cleaning fluid used to clean industrial equipment 10 is generated from concentrated chemical 26. Under the control of controller 30, a target amount of concentrated chemical 26 is dispensed into tank 15 along with a target amount of water to generate a dilute cleaning fluid that is flushed through industrial equipment 10. Concentrated chemical 26 may contain a cleaning agent, a sanitizing agent, or a combination of different agents. For example, concentrated chemical 26 may be, but is not limited to, an alkaline source (e.g., sodium hydroxide, potassium hydroxide), triethanol amine, diethanol amine, monoethanol amine, sodium carbonate, morpholine, sodium metasilicate, potassium silicate, an acid source, a mineral acid (e.g., phosphoric acid, sulfuric acid), an organic acid (e.g., lactic acid, acetic acid, hydroxyacetic acid, citric acid, glutamic acid, glutaric acid, gluconic acid). In addition, although CIP system 8 is illustrated as only having a single concentrated chemical 26, in other examples, the system may include multiple concentrated chemicals that are used either alone or in combination.

For example, CIP system 8 may include a first concentrated chemical that is an alkaline detergent and a second concentrated chemical that is an acidic detergent. Controller 30 may initially combine the alkaline detergent with water in tank 15 and pass the alkaline detergent through industrial equipment 10. The alkaline detergent may help dissolve fat, proteins, and hard deposits, among other components. An intermediate water rinse may or may not be performed on the equipment after the alkaline detergent wash. Subsequently, controller 30 may combine the acidic detergent with water in tank 15 and pass the acidic detergent through industrial equipment 10. The acidic detergent may remove mineral deposits from the equipment and neutralize remaining alkaline detergent on the surfaces of the equipment.

Rinse fluid used in CIP system 8 is typically water, although other suitable fluids can be used. Following a cleaning phase of a CIP process, the rinse fluid can be passed through industrial equipment 10 to flush the equipment of any residual chemical agent remaining in the equipment. This can prepare the industrial equipment to again process product. In some examples, rinse fluid is passed through industrial equipment 10 only a single time before being discarded to drain via conduit 23. In other examples, the rinse fluid is recirculated through CIP system 8 via conduit 21 multiple times before being discarded to drain.

To initiate a CIP cleaning process, controller 30 may receive a CIP request requesting that a CIP cleaning procedure be performed on industrial equipment 10. In response to the request, controller 30 can control CIP system 8 to initiate a sequence of cleaning phase on industrial equipment 10. For example, controller 30 can initiate a pre-rinse phase by opening valve 28 to fill tank 15 with water. When the tank is suitably filled, controller 30 can open valve 29 and activate pump 12 to draw the water from the tank and push pressurized water through industrial equipment 10. As the water contacts internal surfaces of industrial equipment 10, the water may flush soil from the industrial equipment. In different examples, controller 30 opens either valve 31 or 32 to direct the water back to tank 15 or to a drain. At the end of the pre-rinse phase, controller 30 may close valves 28, 29, 31 and/or 32 and stop pump 12.

Following the pre-rinse phase, controller 30 may initiate a cleaning phase by opening valve 34 to dispense concentrated chemical 26 into tank 15 and opening valve 28 to dispense water into the tank. When the tank is suitably filled with a cleaning fluid generated from the concentrated chemical and water, controller 30 can open valve 29 and activate pump 12 to draw the cleaning fluid from the tank and push pressurized cleaning fluid through industrial equipment 10. As the cleaning fluid contacts internal surfaces of industrial equipment 10, the cleaning fluid may clean soil from the surfaces of the industrial equipment, sanitize the surfaces, and the like. Typically, controller 30 opens valve 31 to direct the cleaning solution exiting industrial equipment 10 back into tank 15. Within tank 15, the returned cleaning fluid may be blended with fresh concentrated chemical 26 and/or water and then discharged for recirculation via pump 12 through industrial equipment 10. At the end of the cleaning phase, controller 30 may open valve 32 to discharge the cleaning fluid to drain, stop pump 12, and close valves 28, 29, 31 32, and/or 34.

With the cleaning phase complete, controller 30 may initiate a rinse phase by opening valve 28 to fill tank 15 with water. When the tank is suitably filled, controller 30 can open valve 29 and activate pump 12 to draw the water from the tank and push pressurized water through industrial equipment 10. As the water contacts internal surfaces of industrial equipment 10, the water may flush cleaning fluid and any remaining soil from the industrial equipment. Controller 30 may recirculate the water to tank 15 by opening valve 31 or discharge the water to drain by opening valve 32. At the end of the rinse phase, controller 30 may close valves 28, 29, 31 and/or 32 and stop pump 12. In this manner, controller 30 may control CIP system 8 to perform a series of cleaning phases to clean industrial equipment 10 without disassembling or removing the equipment from its location of normal operation. It should be appreciated, however, that the foregoing description of a CIP cleaning process is merely one example and different CIP cleaning processes may be used. For instance, in some applications, the rinse phase is omitted from the CIP cleaning process, e.g., to prevent contamination of the equipment with bacteria following the cleaning phase.

CIP system 8 includes sensors 22 and 42, though it will be appreciated that different examples can include a different number of sensors, such as a single sensor (e.g., sensor 22), two sensors (e.g., sensors 22 and 42), or more than two sensors. In the illustrated example, sensor 22 is configured to analyze fluid exiting industrial equipment 10 in CIP system 8, and sensor 42 is configured to analyze fluid entering industrial equipment 10 in CIP system 8. In some examples, sensor 22 is configured to analyze the turbidity of the fluid exiting equipment 10, and sensor 42 is configured to analyze the turbidity of the fluid entering equipment 10. In some examples, controller 30 is configured to receive information from sensor 22 regarding the turbidity of the fluid exiting equipment 10 and to receive information from sensor 42 regarding the turbidity of the fluid entering equipment 10.

Turbidity sensors can include sensors configured to output information representative of the turbidity of a fluid under analysis. In some examples, turbidity sensors are further configured to determine other information regarding the fluid under analysis, such as fluorescence or other fluid properties. Example sensors configured to determine at least a turbidity of a fluid are described in U.S. Pat. Nos. 9,618,450, 8,428,611, and 9,557,270, though other example sensors are possible.

In some examples, controller 30 may control one or more aspects of the CIP cleaning process based on a determined turbidity of the fluid. For instance, in some examples, controller 30 can use information from one or more turbidity sensors to determine when a phase of a CIP process is complete, for example, when there is no remaining soil to be removed from equipment being cleaned and/or chemistry being used to perform the CIP process has been consumed, mitigating the efficacy of continuing with the current phase of the process.

Sensor 22 and/or 42 may be implemented in a number of different ways in CIP system 8. In the example shown in FIG. 1, sensor 22 is positioned in-line with a fluid conduit exiting industrial equipment 10 to determine a turbidity of a fluid flowing through the fluid conduit. In other examples, a sample line may be connected to a main conduit exiting industrial equipment 10. In such examples, the sample line can fluidly connect sensor 22 to the main fluid conduit. As fluid moves through the main fluid conduit, a portion of the fluid may enter the sample line and pass adjacent sensor, thereby allowing sensor 22 to determine a turbidity of the fluid flowing through the main fluid conduit. When implemented to receive fluid continuously, sensor 22 may be characterized as an online sensor. In other examples, sensor 22 may be implemented as an offline sensor that receives fluid on an intermittent basis, e.g., by manually filling the sensor with fluid. Similar variations can also be applied to sensor 42.

In one example, sensor 22 receives a fluid exiting industrial equipment 10 via fluid outlet 20 during an alkaline wash phase of the CIP process. Sensor 22 detects the turbidity of the fluid indicating a level of soil in the fluid exiting the equipment and generates therefrom a sensor output representative of the turbidity. Controller 30 receives turbidity information from the sensor 22 and determines a measured turbidity of the fluid based on the received turbidity information. In some examples, controller 30 receives turbidity information from the sensor 22 at a plurality of times. From this information, controller 30 may determine an end of a CIP phase, such as the end of an alkaline wash phase. In some examples, controller 30 is a local controller configured to process information received from the sensor in order to determine the end of the CIP phase. In some cases, the controller 30 can include a local controller configured to communicate with a remote location, such as a cloud-based computing platform, for determining an end of a CIP phase.

A CIP request received by controller 30 that requests initiation of a CIP process may be entered via a user interface or may be stored in a memory associated with the controller. For example, CIP system 8 may include a user interface that presents a variety of preprogrammed CIP cleaning options from which a user may select (e.g., a menu of preprogrammed CIP cleaning processes). As another example, the user interface may permit the user to enter parameters for generating a customized CIP cleaning phase. Parameters specified by the user via the user interface may relate to the intensity of the cleaning process performed by the CIP system. For example, a user may select a flow rate at which pump 12 pumps fluid through industrial equipment 10 at each phase of the CIP process, a duration (e.g., in time or amount of fluid) that the pump pumps fluid through the equipment at each phase of the process, a concentration of chemical(s) used in the cleaning fluid, whether and when fluid is recirculated or discharged to drain during the process, and/or a temperature of the fluid pumped through the equipment.

In some examples, CIP system 8 may be programmed to automatically initiate a CIP cleaning process at prescheduled times or at periodic intervals. Based on information stored in a memory associated with controller 30, the controller can control the various valve(s) and pump(s) in the system to conduct a CIP cleaning process.

CIP system 8 is configured to clean industrial equipment 10. Industrial equipment 10 is conceptually illustrated on FIG. 1 as a single module having an inlet 18 and an outlet 20. The depiction of industrial equipment 10 as a single module is for purposes of illustration and discussion only. It is contemplated that industrial equipment 10 may include one or more individual pieces of industrial equipment (e.g., two, three, four, or more) that each includes an inlet where fluid enters and an outlet where fluid exits. Multiple pieces of industrial equipment can be connected in series to provide a fluid circuit through which fluid travels from one piece of industrial equipment to another piece of industrial equipment. In some examples, industrial equipment 10 defines multiple fluid circuits that each have multiple pieces of industrial equipment connected in series. In such examples, CIP system 8 may have separate pumps and/or fluid conduits fluidly connecting the different fluid circuits to the CIP system 8. Additionally, CIP system 8 may have a fluid/valve manifold to separately connect each of the different fluid circuits to the CIP system.

Examples of individual pieces of industrial equipment 10 include evaporators, separators, fermentation tanks, aging tanks, liquid storage tanks, mash vessels, mixers, pressurized and non-pressurized reactors, driers, heat exchangers, such as HTST heat exchangers (e.g., used in pasteurization of milk, juice, or other products), and homogenizers, though other examples are possible. Industrial equipment 10 can also include flow equipment that provides a mechanism for transporting and/or directing a material that is processed, stored, and/or produced during normal operation of the equipment. For example, the flow equipment may include delivery lines, valves, valve clusters, valve manifolds, restrictors, transfer lines (e.g., pipes, conduits), orifices, and pumps.

CIP system 8 is generally located within an industrial plant that processes a product. The industrial plant may provide for the processing, storage, and/or production of various end products. Exemplary industries that may use CIP system 8 include the food industry, the beverage industry, the pharmaceutical industry, the chemical industry, and the water purification industry. In the case of the food and beverage industry, products processed by industrial equipment 10 (and hence the source of soil remaining in the equipment) can include, but is not limited to, dairy products such as whole and skimmed milk, condensed milk, whey and whey derivatives, buttermilk, proteins, lactose solutions, and lactic acid; protein solutions such as soya whey, nutrient yeast and fodder yeast, and whole egg; fruit juices such as orange and other citrus juices, apple juice and other pomaceous juices, red berry juice, coconut milk, and tropical fruit juices; vegetable juices such as tomato juice, beetroot juice, carrot juice, and grass juice; starch products such as glucose, dextrose, fructose, isomerose, maltose, starch syrup, and dextrine; sugars such as liquid sugar, white refined sugar, sweetwater, and insulin; extracts such as coffee and tea extracts, hop extract, malt extract, yeast extract, pectin, and meat and bone extracts; hydrolyzates such as whey hydrolyzate, soup seasonings, milk hydrolyzate, and protein hydrolyzate; beer such as de-alcoholized beer and wort; baby food, egg whites, bean oils, and fermented liquors.

The composition of the soil being cleaned from industrial equipment 10 will vary depending on the application of the industrial equipment. In general, the soil will include some or all of the product(s) most recently processed on industrial equipment 10 prior to initiating the CIP cleaning process. When industrial equipment 10 provides a heated surface (e.g., a heat exchanger, evaporator), the soil may include a thermally degraded rendering of the product(s) most recently processed on the industrial equipment. Example soils may include a carbohydrate, a proteinaceous matter, food oil, cellulosics, monosaccharides, disaccharides, oligosaccharides, starches, gums, proteins, fats, and oils. In some examples, a soil includes a polycyclic compound and/or a benzene molecule that has one or more substituent electron donating groups such as, e.g., —OH, —NH₂, and —OCH₃, which may exhibit fluorescent characteristics.

Pump 12 in CIP system 8 may be any suitable fluid pressurization device such as a direct lift pump, positive displacement pump, velocity pump, buoyancy pump and/or gravity pump or any combination thereof. In general, components described as valves (28, 29, 31, 32, 34) may be any device that regulates the flow of a fluid by opening or closing fluid communication through a fluid conduit. In various examples, a valve may be a diaphragm valve, ball valve, check valve, gate valve, slide valve, piston valve, rotary valve, shuttle valve, and/or combinations thereof. Each valve may include an actuator, such as a pneumatic actuator, electrical actuator, hydraulic actuator, or the like. For example, each valve may include a solenoid, piezoelectric element, or similar feature to convent electrical energy received from controller 30 into mechanical energy to mechanically open and close the valve. Each valve may include a limit switch, proximity sensor, or other electromechanical device to provide confirmation that the valve is in an open or closed position, the signals of which are transmitted back to controller 30.

Fluid conduits and fluid lines in CIP system 8 may be pipes or segments of tubing that allow fluid to be conveyed from one location to another location in the system. The material used to fabricate the conduits should be chemically compatible with the liquid to be conveyed and, in various examples, may be steel, stainless steel, or a polymer (e.g., polypropylene, polyethylene).

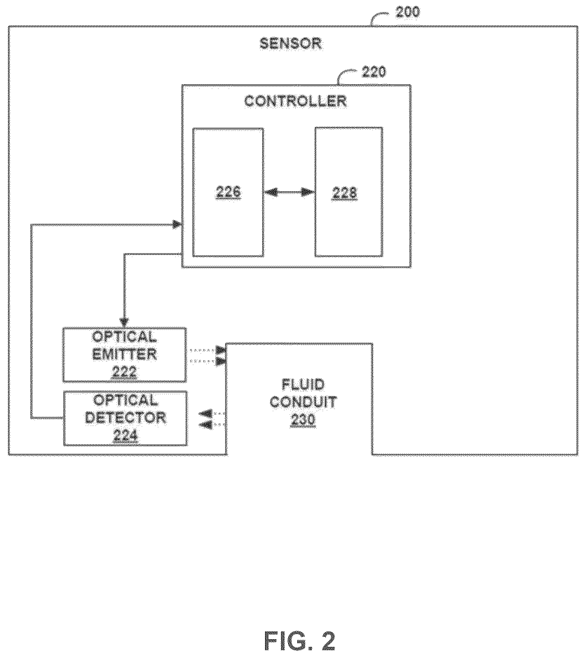

In the example of FIG. 1, sensor 22 analyzes fluid passing through industrial equipment 10, e.g., to determine a turbidity of the fluid. FIG. 2 is a block diagram illustrating an example of a sensor 200 that may be used to analyze a fluid from CIP system 8 to determine information representative of the turbidity of the fluid under analysis. Sensor 200 may be used as sensor 22 in CIP system 8.

With reference to FIG. 2, sensor 200 includes a controller 220, one or more optical emitters 222 (referred to herein as “optical emitter 222”), and one or more optical detectors 224 (referred to herein as “optical detector 224”). Controller 220 (which may be the same as controller 30 in FIG. 1) includes a processor 226 and a memory 228. In operation, optical emitter 222 directs light into fluid (e.g., a pre-rinse fluid containing soil) flowing through fluid conduit 230, and optical detector 224 detects light scattered by the fluid. In some cases, the amount of light scattered by the fluid can be representative of the turbidity of the fluid. For example, when light is directed into a pre-rinse fluid exiting industrial equipment 10 (FIG. 1) and containing soil, soil particles in the fluid can cause light emitted from optical emitter 222 to scatter such that the scattered light is received at optical detector 224. In some examples, optical emitter 222 directs light at one wavelength into fluid flowing through fluid conduit 230 and detects light at the same wavelength via optical detector 224.

In some examples, memory 228 stores software and data used or generated by controller 220. For example, memory 228 may store data used by controller 220 to determine or otherwise analyze turbidity of a fluid from one or more sensors within the system. In some examples, memory 228 stores data in the form of an equation or lookup table that relates a signal output by one or more sensors to a turbidity of the fluid.

Processor 226 runs software stored in memory 228 to perform functions attributed to sensor 200 and controller 220 in this disclosure. Components described as processors within controller 220, controller 30, or any other device described in this disclosure may each include one or more processors, such as one or more microprocessors, digital signal processors (DSPs), application specific integrated circuits (ASICs), field programmable gate arrays (FPGAs), programmable logic circuitry, or the like, either alone or in any suitable combination.

Optical emitter 222 includes at least one optical emitter that emits optical energy into a fluid present with fluid conduit 230. In some examples, optical emitter 222 emits optical energy over a range of wavelengths. In other examples, optical emitter 222 emits optical energy at one or more discrete wavelengths. For example, optical emitter 222 may emit at two, three, four or more discrete wavelengths.

In various examples, optical emitter 222 emits light within the ultraviolet (UV) spectrum, the visible light spectrum, and/or the infrared (IR) spectrum. The specific wavelengths at which optical emitter 222 emits light may vary, e.g., depending on the type of soil expected to be flushed from industrial equipment 10 (FIG. 1). In some examples, optical emitter 222 emits light at a frequency of less than 350 nanometers (nm), such as less than 330 nm, or less than 300 nm. For example, optical emitter 222 may emit light in the frequency range of approximately 275 nm to approximately 335. The foregoing wavelengths are merely examples, however, and other wavelengths of light may be used.

Optical emitter 222 may be implemented in a variety of different ways within sensor 200. Optical emitter 222 may include one or more light sources to excite molecules within the fluid. Example light sources include light emitting diodes (LEDS), lasers, and lamps. In some examples, optical emitter 222 includes an optical filter to filter light emitted by the light source. The optical filter may be positioned between the light source and the fluid and be selected to pass light within a certain wavelength range. In some additional examples, the optical emitter includes a collimator, e.g., a collimating lens, hood or reflector, positioned adjacent the light source to collimate the light emitted from the light source. The collimator may reduce the divergence of the light emitted from the light source, reducing optical noise.

Sensor 200 also includes optical detector 224. Optical detector 224 includes at least one optical detector that detects light scattered by fluid within fluid conduit 230. While shown in FIG. 2 as being on the same side of fluid conduct 230 as optical emitter 222, in some examples, optical detector 224 is positioned on a different side of fluid conduit 230 than optical emitter 222. For example, optical detector 224 may be positioned on a side of fluid conduit 230 that is offset approximately 90 degrees relative to optical emitter 222.

In operation, the amount of optical energy detected by optical detector 224 may depend on the turbidity of the fluid within fluid conduit 230. If the fluid conduit contains a fluid solution that has certain properties (e.g., a certain concentration of soil), optical detector 224 may detect a certain level of optical energy scattered by the fluid. However, if the fluid solution has different properties (e.g., a different concentration of soil), optical detector 224 may detect a different level of optical energy scattered by the fluid. For example, if fluid conduit 230 is filled with a pre-rinse fluid having a first concentration of soil, optical detector 224 may detect a first magnitude of scattered radiation. However, if the fluid conduit is filled with a pre-rinse fluid having a second concentration of soil that is greater than the first concentration, optical detector 224 may detect a second magnitude of radiation that is greater than the first magnitude.

Optical detector 224 may also be implemented in a variety of different ways within sensor 200. Optical detector 224 may include one or more photodetectors such as, e.g., photodiodes or photomultipliers, for converting optical signals into electrical signals. In some examples, optical detector 224 includes a lens positioned between the fluid and the photodetector for focusing and/or shaping optical energy received from the fluid.

Controller 220 controls the operation of optical emitter 222 and receives signals concerning the amount of light detected by optical detector 224. In some examples, controller 220 further processes signals, e.g., to determine a turbidity of the fluid passing through fluid conduit 230.

In one example, controller 220 controls optical emitter 222 to direct radiation into a fluid containing soil and further controls optical detector 224 to detect light scattered by the soil within the fluid. Controller 220 then processes the light detection information to determine the turbidity of the soil in the fluid.

Though FIG. 2 shows an example turbidity sensor based on scattering of light emitted toward the fluid, it will be appreciated that other turbidity sensors are possible. In various examples, turbidity sensors can include light emitters and light sensors on the same side or opposite sides of a flow path. In some cases, a light emitter and sensor can be oriented at an angle with respect to one another, such as 90 degrees or other angles. Some sensors utilize light of multiple wavelengths and/or multiple sensors at different locations (e.g., different angles) to capture different light signals from the fluid simultaneously.

In some cases, turbidity of a fluid flowing through CIP system 8 changes during a phase of a CIP process, for example, as soil is removed from industrial equipment and carried through the CIP system 8 in the fluid flowing therethrough. Often, during operation, one or more aspects of the industrial equipment and/or a fluid flowing through the CIP system evolves as the CIP phase progresses over time. For example, a soil level within the industrial equipment may lessen over time as a CIP phase operates to remove soil therefrom, while the soil level in the fluid rises due to the soil being removed from the industrial equipment. In various example implementations, a CIP phase reaches a point in time in which the CIP phase is no longer effective at affecting the industrial equipment, for example, if the industrial equipment is cleaned of any soils intended to be removed by the CIP phase and/or if chemistry present in the fluid flowing through the CIP system is consumed, reducing the effectiveness of the fluid at advancing the process of the CIP phase. Thus, though aspects of the industrial equipment and/or fluid flowing through the CIP system evolve over time, such aspects may reach a steady state, such as once all soil is removed or fluid chemistry is consumed.

It can be advantageous to detect an endpoint by observing such a steady state of the phase of the CIP process. When the CIP phase reaches a steady state condition, such as when chemistry in a CIP fluid is consumed or there is no target soil to remove from the industrial equipment, additional time spent continuing to flow the CIP fluid through the industrial equipment may cost time and operating resources (e.g., power for running pumps, valves, etc.) while contributing little or no benefit to the system. Thus, in some examples, a system can be configured to determine that the end of the phase of the CIP process has occurred, and the CIP process can be advanced to a next phase. This can be advantageous over other systems, such as time-based systems that run a CIP phase for a predetermined amount of time regardless of whether the flowing of fluid continues to have any efficacy.

However, during a phase of a CIP process intended, for example, to remove soil from industrial equipment, a turbidity measurement might not show a steady change of overall soil in the fluid flowing through the CIP system. For example, soil is not necessarily removed uniformly from the industrial equipment. Additionally, soil removed from the industrial equipment may continue to flow through the CIP system, contributing to subsequent turbidity measurements.

Accordingly, in some examples, when analyzing turbidity of a fluid flowing through a CIP system, the controller is configured to analyze the turbidity of a consistent bolus of fluid. For instance, in some examples, a turbidity sensors outputs information representative of a turbidity of a volume of fluid proximate and/or flowing past the turbidity sensor. A bolus of fluid can include a volume of fluid analyzed by a turbidity sensor at a given time or over a given time duration. A bolus of fluid can be tracked through the CIP system. For example, for fluid flowing through the system at a known flow rate, the location of a given bolus of fluid can be determined relative to a reference time and location. For instance, in an example CIP recirculation system recirculating a fluid, if the fluid path length is X meters and the fluid flow rate is Y meters per second, a bolus of fluid will complete one cycle in the recirculation system in X/Y seconds. Similarly, the bolus of fluid will travel between two known points in the fluid path separated by Z meters in X/Z seconds.

Accordingly, in some examples, the turbidity of a bolus of fluid can be analyzed over time such that each such turbidity measurement reflects the turbidity of the same fluid. For example, in some examples, a controller can be configured to determine the flow rate of a fluid through the CIP system, for example, via measurement, such as by a flow rate meter, or by predetermined pump speed settings and/or specification.

With reference to FIG. 1, a controller 30 can be configured to, during a CIP phase, direct fluid through a fluid path of a CIP system 8. The controller can analyze the turbidity of a bolus of fluid within the fluid path at a first time to provide a first measured turbidity of the bolus of the fluid and analyze the turbidity of the bolus of fluid at a second time to provide a second measured turbidity of the bolus of the fluid. In some such examples, the controller 30 receives information regarding the turbidity of the same fluid or approximately the same fluid at two points in time. In some examples, the bolus of the fluid flows through industrial equipment 10 between the first time and the second time such that soil released from the industrial equipment 10 between the first time and the second time contributes to the turbidity of the bolus of the fluid.

In some examples, analyzing the turbidity of the bolus of the fluid at the first and second time can be performed using a single turbidity sensor. For example, with reference to FIG. 1, sensor 22 can provide turbidity information to the controller 30 representing the turbidity of a bolus of fluid at a first time and can further provide turbidity information to the controller 30 representing the turbidity of the bolus of the fluid at a second time, after the bolus of the fluid completes a recirculation loop and travels through the industrial equipment 10. In such an example, the time difference between the first time and the second time can be the amount of time it takes the bolus of the fluid to complete a recirculation loop in the fluid path.

In other examples, analyzing the turbidity of the bolus of the fluid at the first and second time can be performed using multiple turbidity sensors. For example, with reference to FIG. 1, sensor 42 can provide turbidity information to the controller 30 representing the turbidity of a bolus of fluid at a first time, and sensor 22 can provide turbidity information to the controller 30 representing the turbidity of the bolus of the fluid at a second time. In some such examples, the time difference between the first time and the second time is the time it takes the bolus of the fluid to flow from sensor 42 to sensor 22, during which time the bolus of the fluid flows through industrial equipment 10.

As discussed above, in some cases, when a system reaches an equilibrium, it can indicate that the CIP phase is having no more effect on the industrial equipment, such as due to soil being depleted from the equipment and/or chemistry in the fluid being consumed. In some examples, such an equilibrium can be detected by the industrial equipment having little or no effect on the turbidity of the fluid flowing therethrough. In some examples, the controller is configured to determine an end of a phase of a CIP process based on the first measured turbidity and the second measured turbidity. For example, in some examples, if the first measured turbidity and the second measured turbidity are such that the CIP phase is in equilibrium and no new soil is being added to the system from the industrial equipment. The controller can be configured to determine that the end of the CIP phase has occurred, for example, via local processing and/or leveraging cloud-based computing. For instance, in some examples, the controller comprises a local controller configured to communicate data to a cloud-based computing platform where the data can be processed to determine an end of a CIP phase. The cloud-based computing platform can communicate to the local controller that a CIP phase is complete.

In some examples, upon determining the end of the CIP process (e.g., by local data processing or using a cloud-based computing platform), the controller can control the CIP process. For example, the controller can control one or more valves to proceed to a subsequent phase of the overall CIP process or end the CIP process. In some examples, the controller can drain a fluid from the fluid path, such as a CIP fluid containing soil from the industrial equipment, by controlling a valve (e.g., 32) to direct fluid to a drain (e.g., via conduit 23). Additionally or alternatively, a controller can cause one or more additional fluids to be added to the fluid path for performing one or more subsequent CIP phase(s).

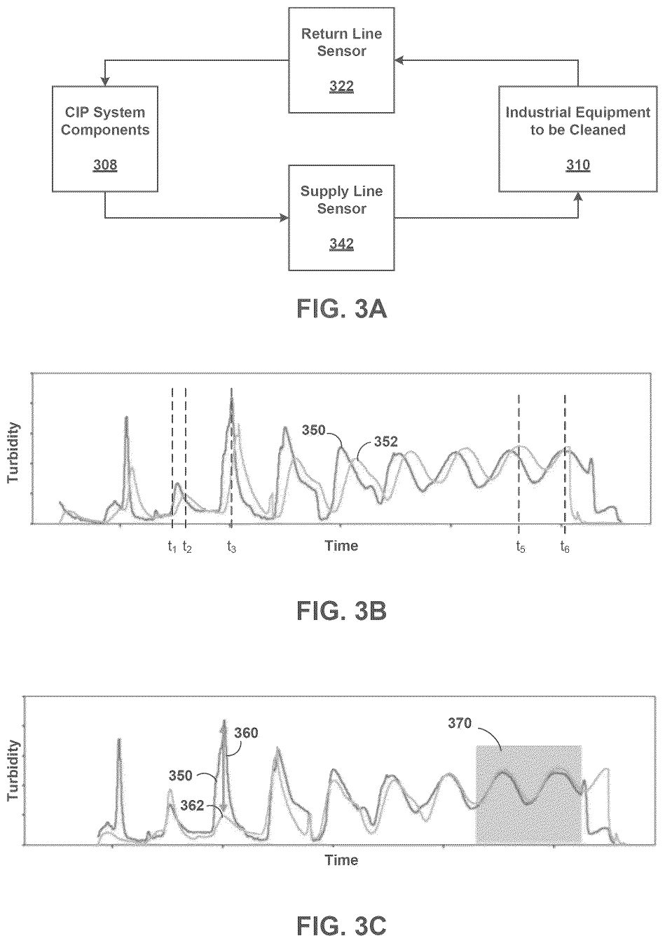

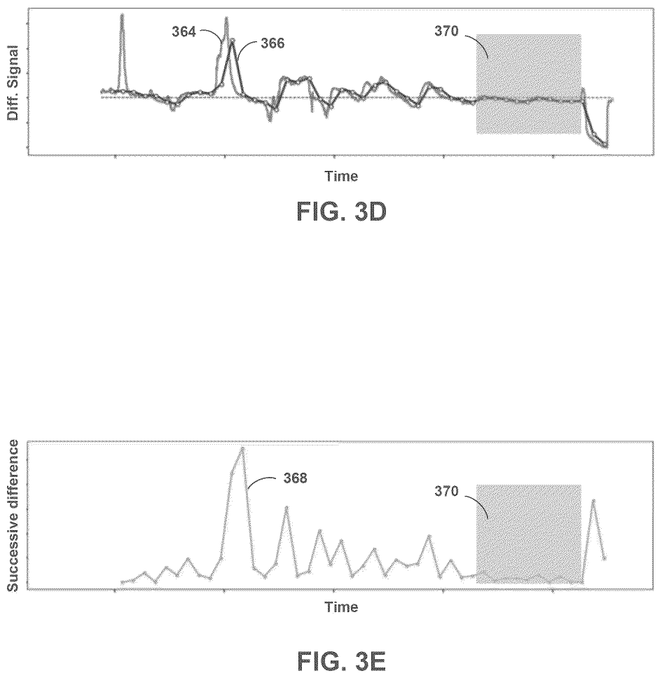

In some examples, multiple sensors (e.g., sensors 22 and 42 in FIG. 1) positioned on either side of industrial equipment to be cleaned can be used to assess the progress of a CIP phase. FIGS. 3A-3E show an example system and data that can be used to monitor the progress of a CIP phase. FIG. 3A shows a high-level schematic diagram of a CIP system used for cleaning equipment. As shown, CIP system components 308 (e.g., one or more valves, conduits, pumps, etc.) are in fluid communication with industrial equipment to be cleaned 310. A supply line sensor 342 is positioned and configured to provide turbidity information regarding fluid entering the industrial equipment 310 and a return line sensor 322 is positioned and configured to provide turbidity information regarding fluid exiting the industrial equipment 310. In some examples, the configuration of supply line sensor 342, industrial equipment 310, and return line sensor can be used as sensor 42, equipment 10, and sensor 22, respectively, in the illustrated system of FIG. 1. During example operation of a CIP phase, a CIP fluid is provided to the industrial equipment to be cleaned 310. The fluid encounters supply line sensor 342 before reaching equipment 310 and return line sensor 322 after leaving equipment 310. In some examples, the fluid recirculates through the CIP system, such as via one or more pumps as part of the CIP system components 308. A controller can receive information from the supply line sensor 342 and the return line sensor 322 in order to analyze turbidity at each location during the CIP phase.

FIG. 3B shows a plot of example turbidity information received by the controller from the supply line sensor 342 and the return line sensor 322. The plot includes supply line sensor data 352 and return line sensor data. In the illustrated example, a CIP phase (e.g., an alkaline wash phase) is initiated at time t₁. At time t₂, the supply line sensor data 352 shows a small peak in turbidity, and at time t₃, the return line sensor data shows a larger peak in turbidity.

In some examples, the time difference between t₂ and t₃ is the amount of time it takes the fluid circulating in the CIP system to travel between the supply line sensor 342 and the return line sensor. In some such examples, the turbidity measured at the supply line sensor 342 at time t₂ represents a turbidity of the same bolus of fluid as is represented by the turbidity measured at the return line sensor 322 at time t₃. Similarly, a turbidity measured at the supply line sensor 342 at time t₅ represents a turbidity of the same bolus of fluid as is represented by the turbidity measured at return sensor line 322 at time t₆.

FIG. 3C shows a plot of example turbidity information received by the controller from the supply line sensor 342 and the return line sensor 322 with the turbidity information from the supply line sensor 342 is shifted by the time difference between t2 and t3. The example plot of FIG. 3C shows shifted supply line sensor data 362 and the return line sensor data 350. Because the supply line sensor data 362 is shifted by the amount of time it takes a bolus of fluid to travel between the supply line sensor 342 and the return line sensor 322, a given time in the plot of FIG. 3C shows turbidity information of the same bolus of fluid at the supply line sensor 342 (based on shifted supply line sensor data 362) and the return line sensor 322 (based on return line sensor data 350). Accordingly, at a given time in the plot of FIG. 3C, the difference between the shifted supply line sensor data 362 and the return line sensor data 350 represents a difference in turbidity for a given bolus of fluid at the supply line sensor 342 and return line sensor 322. For example, arrow 360 represents a difference in the turbidity of a given bolus of fluid as measured by the supply line sensor 342 at time t2 and as measured by the return line sensor 322 at time t3.

In some examples, a controller is configured to receive turbidity information from the supply line sensor 342 and return line sensor 322 and temporally shift at least one of the data sets by the amount of time it takes a bolus of fluid to travel between the supply line sensor 342 and the return line sensor 322. The controller can be configured to calculate a turbidity difference signal based on the difference between a continuous turbidity signal from the return line sensor 322 and a temporally offset continuous turbidity signal from the supply line sensor 342. For instance, in some examples the controller can determined a turbidity difference signal based on the difference between return line sensor data 350 and shifted supply line sensor data 362 as shown in FIG. 3C.

FIG. 3D shows an example calculated difference signal 364. As described, difference signal 364 can represent the difference between return line sensor data 350 and shifted supply line sensor data 362 as shown in FIG. 3C. FIG. 3D also shows a smoothed difference signal 366. In some examples, a smoothed difference signal can be calculated (e.g., by the controller) based on a rolling average or rolling median of data from the raw difference signal. Other smoothing processes can be used to provide a smoothed difference signal, such as a Kalman filter. In various examples, the smoothed difference signal comprises an average or median of a predetermined number of preceding raw difference values. In some examples, the smoothed difference signal is calculated using between 30 seconds and 120 seconds of data, and in some examples, a smoothed difference signal can be calculated using approximately 60 seconds of data. In some examples, the smoothed difference signal comprises one data point per period of time used to calculate the smoothed difference signal value. For instance, in some examples, if a rolling median is calculated over a period of one minute, the smoothed difference signal can include one data point per minute of time. In some examples, the smoothed difference signal comprises more than one data point per period of time used to calculate the smoothed difference signal value. For instance, in an example embodiment, each data point of the smoothed difference signal is calculated using a previous 120 data points (e.g., over 120 seconds of data), and the smoothed difference signal comprises one such data point every 60 seconds.

As shown in the example of FIG. 3D, in some examples, a difference signal can include a continuous signal, such as shown in difference signal 364. In other examples, a smoothed difference signal can be calculated using, for example, a rolling median calculation. As described, in some examples, such a smoothed difference signal can include a discrete signal, such as one representative data point for every second.

In an example, a system controller can be configured to determine a difference signal Z by the equation Z=TRₜ−TS_{t-PT}, wherein TRₜ is a return turbidity value (e.g., from return line sensor 322) at time t, and TS_{t-PT} is a supply turbidity value (e.g., from supply line sensor 342) at a time t−PT, where PT is the time it takes for a bolus of fluid to flow between the supply line sensor 342 and the return line sensor 322. As discussed, such a difference signal can correspond to a difference in turbidity of a bolus of fluid as measured before and after the bolus of the fluid flows through the industrial equipment to be cleaned 310. Accordingly, the difference signal Z can represent additional soil added to the fluid from the industrial equipment being cleaned 310.

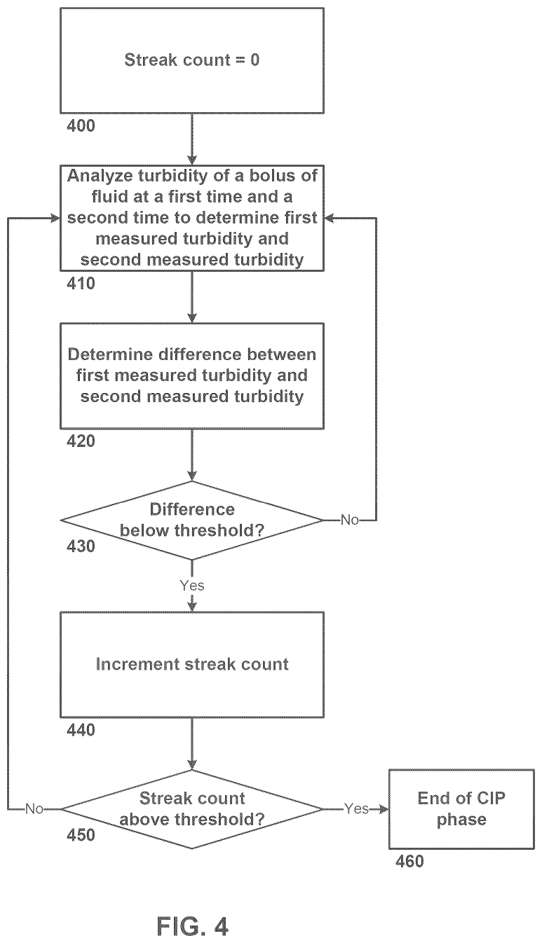

In some examples, a controller can be configured to determine an end of a CIP phase if the difference signal drops below a predetermined difference threshold. For instance, in some cases, if a fluid flowing through the industrial equipment to be cleaned 310 does not affect the turbidity of the fluid (resulting in a low or zero difference signal), it can indicate that no cleaning progress is being made at the industrial equipment. Thus, this can be used as an indication that the CIP phase is complete, and subsequent running of the same phase may add cost without benefit. In some examples, determining the end of a CIP phase based on the difference signal further comprises determining if the difference signal is below a predetermined difference threshold for a predetermined amount of time. This can reduce the likelihood of a false determination of the completion of a CIP phase based on a single data point. In some examples, an end of a CIP phase corresponds to a change in turbidity caused by equipment being and remaining below a threshold. FIG. 4 shows an example process flow diagram that involves a determining an end of a CIP phase using a difference analysis.

In the illustrated example, a streak count starts at zero (400). The process continues with analyzing turbidity of a bolus of fluid at a first time and a second time to determine a first measured turbidity and a second measured turbidity (410), and determining a difference between the first measured turbidity and the second measured turbidity (420). As described herein, in some examples, this step includes comparing turbidity of a bolus of fluid using two sensors positioned upstream and downstream of industrial equipment to be cleaned. In other examples, this includes analyzing turbidity information from a single sensor taken at multiple times.

The difference can be compared to a predetermined difference threshold (430). If the difference is not below the threshold, further turbidity analysis can be performed (410) and the process continues. If the difference is below the threshold, the streak count can be incremented (440). The incremented streak count can be compared to a streak threshold (450), and if the streak count is not above the streak threshold, further turbidity analysis can be performed (410). However, in the illustrated example, if the streak count is above the threshold, in some cases, indicating the turbidity changes have remained low over at least a threshold duration, the end of the CIP phase can be determined to have occurred (460).

In some examples, analyzing a turbidity difference over a known period of time comprises determining a rate of change of the turbidity over time. In some examples, determining whether a turbidity difference is below a threshold comprises comparing the rate of change of turbidity to at threshold. In some such examples, if the rate of change is below the rate of change threshold, the end of the CIP phase can be determined to have occurred. In other examples, if a particular instance of a turbidity rate of change is below the rate of change threshold, a streak count can be incremented, similar to step 440, and an end of the CIP phase can be determined to have occurred if the streak count rises above a streak threshold, for example, wherein the rate of change of turbidity has remained low for a threshold period of time.

With reference back to FIG. 3C, during time window 370, the difference in turbidity between the return and supply signals in low, suggesting that the equipment being cleaned is not releasing soil and adding to the turbidity of the fluid flowing therethrough. Similarly, in FIG. 3D, the difference signal is low during time window 370. Using a method similar to that of FIG. 4, in some cases, an end of a CIP phase can be determined to have occurred during such a window. In some examples, in response to determining the end of the CIP phase has occurred, the CIP phase can be stopped. In some examples, with reference to FIG. 3D, the end of the CIP phase can be determined to have occurred at or near the beginning of time window 370, meaning that ending the CIP phase upon such detection can result in a time savings of some or all of the duration of time window 370.

In some examples, a turbidity difference signal or a smoothed difference signal can be used to calculate a successive difference signal. A successive difference signal can include data representing a difference between consecutive data points in the difference signal. FIG. 3E shows an example successive difference signal 368 showing a difference between consecutive points on the smoothed difference signal 366 of FIG. 3D.

In some examples, a controller can be configured to determine a successive difference signal by comparing consecutive measurements of the difference signal Z. In an example, a successive difference SD=|Zₜ−Zₜ₋₁| where Zₜ is a difference value at time t and Zₜ₋₁ is a preceding difference value, for example, a difference value calculated using a rolling median difference a minute prior. In some examples, the difference between t and t−1 can be based on a difference measurement rate, and the difference between times t and t−1 can be, for example, one minute, two minutes, or other predetermined time differences. For example, using a one minute time difference, a first successive difference can be calculated by taking an average (e.g., median) of values in a 61s to 120s time range and subtracting an average (e.g., median) of values in a 0s to 60s time range. In some examples, the time difference between t and t−1 corresponds to the amount of time used to determine a rolling median value of the difference signal. In some examples, the time difference between t and t−1 corresponds to the difference in time between successive smoothed data points (e.g., such that a successive difference value is the difference between a current smoothed data point and the previous smoothed data point).

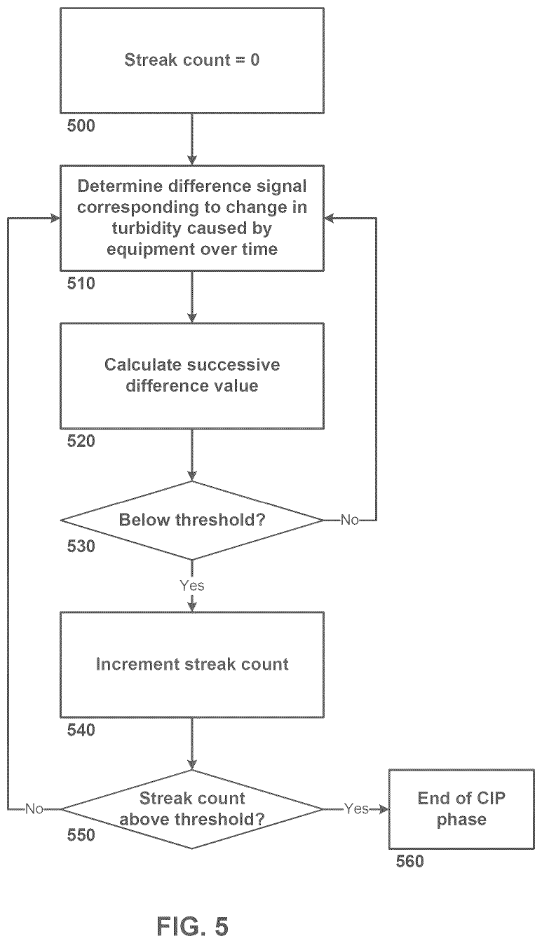

In some examples, successive difference data can be used to determine an end of a CIP phase. For example, if a successive difference data point (e.g., a difference between consecutive difference values) is below a predetermined threshold, the changes in turbidity due to the industrial equipment being cleaned are steady over time. FIG. 5 shows an example analysis of a successive difference signal to determine an end of a phase of a CIP process has occurred. In the example of FIG. 5, a streak count begins at zero (500). The step continues with determining a difference signal corresponding to a change in turbidity caused by equipment being cleaned (510), which can be determined using processes described herein. The process further includes calculating a successive difference value (520), for example, as described herein. The successive difference signal can include, for example, the difference between consecutive points of a smoothed difference signal, such as rolling median values of difference data corresponding to consecutive minutes of data.

The successive difference value can be compared to a successive difference threshold (530), and if the successive difference value is not below the threshold, additional difference signal information can be determined as the CIP phase continues (510). If the successive difference value is below the threshold, the streak count can be incremented (540) and compared to a streak threshold (550). If the streak count is not above the threshold, additional difference signal information can be determined as the CIP phase continues (510). However, if the streak count is above the streak threshold, then the end of the CIP phase can be determined to have occurred (560).

In some examples, with reference to FIG. 3E, the end of the CIP phase can be determined to have occurred at or near the beginning of time window 370, wherein the successive difference signal is low and remains low. Thus, in some such instances, ending the CIP phase upon such detection can result in a time savings of some or all of the duration of time window 370.

The example processes of FIGS. 4 and 5 can be implemented, for example, by a controller in communication with one or more turbidity sensors such as in the configurations described herein.

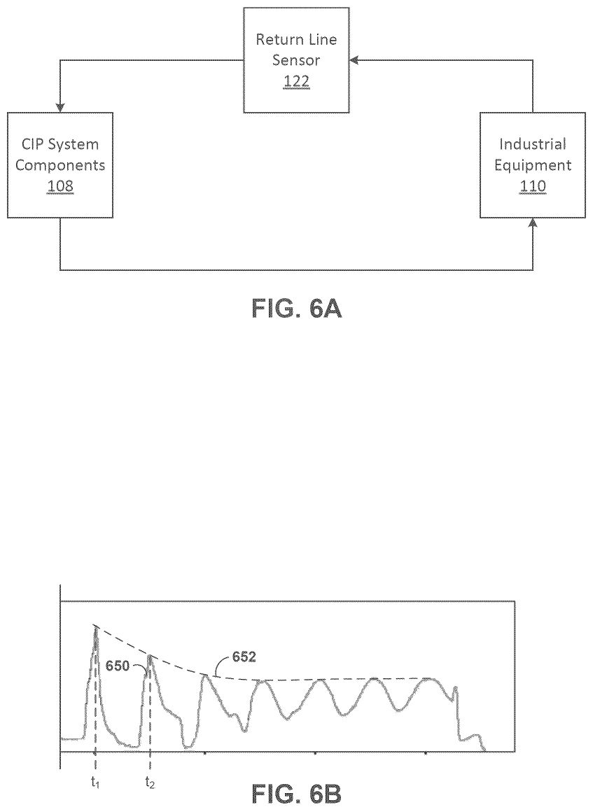

While shown in the example of FIG. 3A as including multiple turbidity sensors, various examples described herein can be implemented using a single turbidity sensor. FIG. 6A shows an example CIP system including industrial equipment to be cleaned 110, a return line sensor 122 positioned downstream of the equipment 110, and other CIP system components 108, such as one or more pumps, valves, or the like, that can be used to move fluid through the CIP system. While shown as including a single return line sensor 122, in other examples, a single turbidity sensor can be positioned elsewhere in the CIP system, such as on the supply side of the equipment 110.

FIG. 6B shows an example plot of a turbidity signal 650 from a turbidity sensor over time. As shown, turbidity signal 650 has periodic relative maxima and minima over time. In some cases, this can be caused by a burst of soil expelled from equipment being cleaned that causes localized high turbidity in fluid flowing through the system. For instance, in an example, turbidity of a bolus of fluid containing soil released from equipment being cleaned is analyzed at a first time, t₁, and a second time, t₂, wherein the difference between times t₁ and t₂ is the amount of time it takes the bolus of fluid to circulate through the CIP system.

Similar to as described elsewhere herein, in some examples, a difference signal representing a change in turbidity of a given bolus of fluid can be determined using the signal 650 from the single sensor, for example, by subtracting a turbidity at time t2 from the turbidity at time t1. In some examples, a continuous difference signal can be calculated by determining a difference between the turbidity signal 650 and a version of the turbidity signal temporally offset by the time it takes a bolus of fluid to circulate through the system. For instance, in an example, a difference signal can be calculated using the equation Z=TRₜ−TRₜ₋ₚₜ wherein TRₜ is the turbidity at a return sensor at a time t and TRₜ₋ₚₜ is the turbidity at the return sensor at a time offset from the time t by a pass time pt corresponding an amount of time it takes a bolus of fluid to circulate through the CIP system. Whether the single sensor is positioned on the supply or return side of the equipment to be cleaned, the bolus of fluid, between the times separated by pass time pt, will have traveled through the equipment to be cleaned, wherein the turbidity of the bolus of the fluid may have been affected by soil leaving the equipment. In some examples, such single sensor data separated by a known time (in this example, pass time pt) can be used to determine a turbidity rate of change, which can be assessed to determine whether an end of a CIP phase has occurred such as described elsewhere herein.

Similar to described above with respect to a two-sensor design, a difference signal can be generated from a single sensor design, and can be used to determine an end of a CIP phase, for example, if the difference signal falls below a threshold or, in some examples, remains below the threshold for a predetermined amount of time. Additionally or alternatively, such a difference signal can be used to generate a smoothed difference signal, for example, by using a rolling median value of a calculated difference signal over time. In some examples, a successive difference approach such as described above with respect to the two-sensor design can be similarly applied with the single sensor design. For example, in some examples, a successive difference value SD=|Zₜ−Zₜ₋₁| similar to as described above, where Zₜ is a difference value at time t and Zₜ₋₁ is a preceding difference value, for example, a difference value calculated using a rolling median difference a minute prior. In some examples, the difference in time between t and t−1 is an amount of time between an immediately preceding smoothed difference signal data point.

In some examples, turbidity data over time, such as data from a sensor, a difference signal generated by a single sensor or by multiple sensors, or a successive difference signal, can be fit to a turbidity model. In some examples, fitting turbidity data to a model can be used to determine an end of a CIP phase. In some examples, the model can provide an estimated time after which the phase would be complete. In some such cases, the estimated time can be updated after each new data point (e.g., each new smoothed data point) is calculated. FIG. 6B includes a turbidity model 652 fit to the turbidity signal 650. In some examples, the model 652 can be used to determine and end of a CIP phase, such as when the model crosses a predetermined point along the horizontal or vertical axis. In some examples, turbidity data fit to a model includes raw turbidity data, turbidity rate of change data, periodically sampled turbidity data (e.g., turbidity data sampled from one or more sensors each time a turbidity of a bolus of fluid is detectable by such one or more sensors), a turbidity difference signal, or successive difference data.

Various examples of analyzing turbidity at a plurality of times have been described. For example, in various examples, changes in the turbidity of a bolus of fluid can indicate that a CIP phase is not yet complete, as equipment to be cleaned continues to dispense soil into the CIP system. However, various processes can be used to determine an end of a CIP phase based on turbidity measurements as a plurality of times such as described herein.

In various examples wherein one or more threshold values are used (e.g., a count threshold, a turbidity difference threshold, a turbidity range of change threshold, etc.). Thresholds can be stored in a memory (e.g., memory 228). Specific thresholds stored in memory 228 may depend, e.g., on the characteristics of the soil being cleaned, the cleanliness requirements for the product produced using industrial equipment 10, the availability of various CIP cleaning fluids, the geometry and/or number of fluid flow paths, the number of fluid sources, or other system parameters.

In various examples, during operation of CIP system 8, controller 30 can control the components of the system to flush industrial equipment 10 with pre-rinse fluid, e.g., until a turbidity of the pre-rinse fluid reaches a steady state (e.g., a turbidity difference, a turbidity rate of change, or other metric meets one or more threshold values as described herein). At this point, controller 30 may control CIP system 8 to terminate the pre-rinse phase and begin a cleaning phase, such as an alkaline wash phase. Similar steps can be performed, wherein the controller 30 can control components of the system of circulate, for example, an alkaline chemistry through the equipment to be cleaned to remove soil therefrom until the turbidity of the system reaches a steady state. Such a steady state can indicate that the soil targeted in the alkaline wash phase has been substantially removed from the equipment and/or that the chemistry has been consumed. At this point, controller 30 may control CIP system 8 to terminate the alkaline wash phase and begin a new phase, such as a rinsing phase. Various phases can be controlled in a similar manner.

In some examples, systems can be configured to generate an output indicating that a phase has ended. Such an output can be provided, for example, via a user interface in communication (e.g., wired or wireless communication) with the controller. Example interfaces can include a display screen proximate and in connection with the controller of the CIP system, or a networked interface in communication with the controller via a network. In some examples, controller can be configured to send a notification that a CIP phase has ended, for example, via an email message, text message, or other remote communication method.

The techniques described in this disclosure, including functions performed by a controller, control unit, or control system, may be implemented within one or more of a general purpose microprocessor, digital signal processor (DSP), application specific integrated circuit (ASIC), field programmable gate array (FPGA), programmable logic devices (PLDs), or other equivalent logic devices. Accordingly, the terms “processor” or “controller,” as used herein, may refer to any one or more of the foregoing structures or any other structure suitable for implementation of the techniques described herein.

The various components illustrated herein may be realized by any suitable combination of hardware, software, firmware. In the figures, various components are depicted as separate units or modules. However, all or several of the various components described with reference to these figures may be integrated into combined units or modules within common hardware, firmware, and/or software. Accordingly, the representation of features as components, units or modules is intended to highlight particular functional features for case of illustration, and does not necessarily require realization of such features by separate hardware, firmware, or software components. In some cases, various units may be implemented as programmable processes performed by one or more processors or controllers.

In some examples, one or more processors or controllers can leverage additional processing resources, such as cloud-based resources. For instance, in some cases, a system can include a local controller in communication with various local devices, such as sensors, pumps, valves, of a system. The local controller can be configured to communicate data to a remote location, such as a cloud-based computing platform, for data analysis. One or more processing steps described herein can be performed at the remote location (e.g., via cloud computing) and the local controller can be configured to receive the results of one or more such processing steps. The local controller can be configured to engage with other local components based on the results of the remote processing.

Any features described herein as modules, devices, or components may be implemented together in an integrated logic device or separately as discrete but interoperable logic devices. In various aspects, such components may be formed at least in part as one or more integrated circuit devices, which may be referred to collectively as an integrated circuit device, such as an integrated circuit chip or chipset. Such circuitry may be provided in a single integrated circuit chip device or in multiple, interoperable integrated circuit chip devices.

If implemented in part by software, the techniques may be realized at least in part by a computer-readable data storage medium (e.g., a non-transitory computer-readable storage medium) comprising code with instructions that, when executed by one or more processors or controllers, performs one or more of the methods and functions described in this disclosure. The computer-readable storage medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), embedded dynamic random access memory (eDRAM), static random access memory (SRAM), flash memory, magnetic or optical data storage media. Any software that is utilized may be executed by one or more processors, such as one or more DSP's, general purpose microprocessors, ASIC's, FPGA's, or other equivalent integrated or discrete logic circuitry.

The following example may provide additional details about CIP systems and techniques in accordance with this disclosure.

1. A method comprising:
directing a fluid through a fluid path that includes industrial equipment during a phase of a clean-in-place (CIP) process to remove soil from the industrial equipment;
analyzing a turbidity of a bolus of the fluid within the fluid path at a first time to provide a first measured turbidity of the bolus of the fluid;
analyzing the turbidity of the bolus of the fluid within the fluid path at a second time to provide a second measured turbidity of the bolus of the fluid, wherein the bolus of the fluid travels through the industrial equipment between the first time and the second time;
determining an end of the phase of the CIP process based on the first measured turbidity and the second measured turbidity; and
controlling the CIP process based upon the determined end of the phase of the CIP process.

2. The method of claim 1, wherein:
directing the fluid through the fluid path comprises recirculating the fluid through a recirculation loop;
analyzing the turbidity of the bolus of the fluid at the first time comprises measuring the turbidity of the bolus of the fluid using a turbidity sensor at a first position within the fluid path;
analyzing the turbidity of the bolus of the fluid at the second time comprises measuring the turbidity of the bolus of the fluid using the turbidity sensor at the first position; and
the first time is temporally offset from the second time by an amount of time it takes for the bolus of the fluid to complete one cycle through the recirculation loop of the fluid path.

3. The method of claim 2, wherein determining the end of the phase of the CIP process based on the first measured turbidity and the second measured turbidity comprises:
determining a difference between the first measured turbidity and the second measured turbidity;
comparing the determined difference to a predetermined difference threshold; and
if the determined difference is less than the predetermined difference threshold, determining the end of the phase of the CIP process has occurred.

4. The method of claim 1, wherein determining the end of the phase of the CIP process based on the first measured turbidity and the second measured turbidity comprises:
determining a difference between the first measured turbidity and the second measured turbidity;
comparing the determined difference to a predetermined difference threshold; and
if the determined difference is less than the predetermined difference threshold, incrementing a running count of consecutive instances of measured turbidity differences being below the predetermined difference threshold; and
if the running count of consecutive instances of measured turbidity differences being below the predetermined difference threshold meets a predetermined streak threshold, determining the end of the phase of the CIP process has occurred.

5. The method of claim 1, wherein:
analyzing the turbidity of the bolus of the fluid at the first time comprises measuring the turbidity of the bolus of the fluid using a first turbidity sensor at a first position within the fluid path;
analyzing the turbidity of the bolus of the fluid at the second time comprises measuring the turbidity of the bolus of the fluid using a second turbidity sensor at a second position within the fluid path, the second position being different from the first; and
the first time is temporally offset from the second time by an amount of time it takes for the bolus of the fluid to travel through the fluid path between the first position and the second position.

6. The method of claim 5, wherein
directing the fluid through the fluid path comprises recirculating the fluid through a recirculation loop;
measuring the turbidity of the bolus of the fluid using the first turbidity sensor comprises continuously measuring the turbidity of the fluid by the first turbidity sensor as the fluid flows through the recirculation loop to provide a first continuous measured turbidity; and
measuring the turbidity of the bolus of the fluid using a second turbidity sensor comprises continuously measuring the turbidity of the fluid by the second turbidity sensor as the fluid flows through the recirculation loop to provide a second continuous turbidity signal.

7. The method of claim 6, further comprising:
calculating a turbidity difference signal, the turbidity difference signal comprising a difference between the first continuous measured turbidity signal and a temporally offset second continuous measured turbidity signal, the temporally offset second continuous measured turbidity signal comprising the second continuous turbidity signal temporally offset by the amount of time it takes for the bolus of the fluid to travel through the fluid path between the first position and the second position; and wherein
determining the end of the phase of the CIP process based on the first measured turbidity and the second measured turbidity comprises determining the end of the phase of the CIP process based on the turbidity difference signal.

8. The method of claim 7, wherein determining the end of the phase of the CIP process based on the turbidity difference signal comprises determining the phase of the CIP process has ended if the turbidity difference signal is less than a predetermined difference threshold for a predetermined period of time.

9. The method of claim 7, further comprising determining a smoothed difference signal based on the turbidity difference signal, and wherein determining the end of the phase of the CIP process based on the turbidity difference signal comprises determining the phase of the CIP process has ended if the smoothed difference signal is less than a predetermined difference threshold for a predetermined period of time.

10. The method of claim 9, wherein determining the smoothed difference signal comprises a calculating a rolling median value or a rolling average value of the turbidity difference signal over time.

11. The method of claim 1, further comprising:
determining a difference between the first measured turbidity and the second measured turbidity;
comparing the determined difference between the first measured turbidity and the second measured turbidity to a predetermined difference threshold; and
if the difference between the first measured turbidity and the second measured turbidity is less than the predetermined difference threshold, determining the end of the phase of the CIP process has occurred.

12. The method of claim 11, further comprising, if the difference between the first measured turbidity and the second measured turbidity is not less than the predetermined difference threshold:
analyzing the turbidity of the bolus of the fluid within the fluid path at a third time to provide a third measured turbidity of the bolus of the fluid, wherein the bolus of the fluid travels through the industrial equipment between the second time and the third time;
determining a difference between the second measured turbidity and the third measured turbidity;
comparing the determined difference between the second measured turbidity and the third measured turbidity to the predetermined difference threshold; and
if the difference between the second measured turbidity and the third measured turbidity is less than the predetermined difference threshold, determining the end of the phase of the CIP process has occurred.

13. The method of claim 1, further comprising:
acquiring turbidity data over a period of time, the period of time comprising the first time and the second time; and wherein
determining the end of the phase of the CIP process based on the first measured turbidity and the second measured turbidity comprises fitting the turbidity data over time to a turbidity model.

14. The method of claim 1, further comprising:
acquiring turbidity data over a period of time, the period of time comprising the first time and the second time; and wherein
determining the end of the phase of the CIP process based on the first measured turbidity and the second measured turbidity comprises:
determining a time rate of change of the turbidity data; and
if the time rate of change of the turbidity data meets a predetermined turbidity rate of change threshold condition, determining the end of the CIP process has occurred.

15. The method of claim 1, wherein the phase of the CIP process comprises an alkaline circulation phase.

16. The method of claim 1, wherein determining the end of the phase of the CIP process based on the first measured turbidity and the second measured turbidity comprises predicting a future endpoint of the phase of the CIP process based on the first measured turbidity and the second measured turbidity.

17. The method of claim 1, wherein the industrial equipment comprises one or more of a heat exchanger, a tank, a pipe, a filter, and a valve.

18. The method of claim 1, wherein controlling the CIP process based upon the determined end of the phase of the CIP process comprises electronically controlling the CIP process.

19. The method of claim 18, wherein electronically controlling the CIP process comprises at least one of adjusting a rate at which the fluid is directed through the industrial equipment, stopping a flow of the fluid through the industrial equipment, and adjusting a chemical composition of the fluid.

20. The method of claim 18, wherein:
the phase of the CIP process is a cleaning phase; and
electronically controlling the CIP process upon determining the end of the phase comprises terminating the cleaning phase and initiating a rinse phase.

21. The method of claim 1, wherein the bolus of the fluid comprises a volume of fluid that flows through a predetermined length of the fluid path in a predetermined amount of time.

22. A measurement and control system for a clean-in-place (CIP) process comprising:
a turbidity sensor positioned in a fluid path of a CIP process, the fluid path including industrial equipment and the CIP process removing soil from the industrial equipment; and
a controller in communication with the turbidity sensor and configured to:
receive turbidity information from the turbidity sensor indicative of a turbidity of a bolus of fluid in the fluid path;
determine a first measured turbidity of the bolus of fluid based on the turbidity information received from the turbidity sensor, the first measured turbidity representing the turbidity of the bolus of the fluid at a first time;
determine a second measured turbidity of the bolus of fluid, the second measured turbidity representing the turbidity of the bolus of the fluid at a second time, and wherein the bolus of fluid travels through the industrial equipment in the fluid path between the first time and the second time;
determine an end of a phase of a CIP process based on the first measured turbidity and the second measured turbidity; and
control the CIP process based upon the determined end of the phase of the CIP process.

23. The system of claim 22, wherein
the fluid path comprises a recirculation loop such that the bolus of fluid flows through the recirculation loop during the phase of the CIP process;
the first time is temporally offset from the second time by an amount of time it takes for the bolus of the fluid to complete one cycle through the recirculation loop of the fluid path; and
determining the second measured turbidity of the bolus of fluid comprises determining the second measured turbidity based on turbidity information received from the turbidity sensor.

24. The system of claim 23, wherein determining the end of the phase of the CIP process based on the first measured turbidity and the second measured turbidity comprises:
determining a difference between the first measured turbidity and the second measured turbidity;
comparing the determined difference to a predetermined difference threshold; and
if the determined difference is less than the predetermined difference threshold, determining the end of the phase of the CIP process has occurred.

25. The system of claim 22, wherein determining the end of the phase of the CIP process based on the first measured turbidity and the second measured turbidity comprises:
determining a difference between the first measured turbidity and the second measured turbidity;
comparing the determined difference to a predetermined difference threshold; and
if the determined difference is less than the predetermined difference threshold, incrementing a running count of consecutive instances of measured turbidity differences being below the predetermined difference threshold; and
if the running count of consecutive instances of measured turbidity differences being below the predetermined difference threshold meets a predetermined streak threshold, determining the end of the phase of the CIP process has occurred.

26. The system of claim 22, wherein the turbidity sensor comprises a first turbidity sensor located at a first position in the fluid path and the system further comprises a second turbidity sensor located at a second position in the fluid path; and wherein
determining the first measured turbidity of the bolus of the fluid comprises measuring the turbidity of the bolus of the fluid using the first turbidity sensor at the first time;
determining the second measured turbidity of the bolus of the fluid comprises measuring the turbidity of the bolus of the fluid using a second turbidity sensor at the second time; and
the first time is temporally offset from the second time by an amount of time it takes for the bolus of the fluid to travel through the fluid path between the first position and the second position.

27. The system of claim 26, wherein:
the fluid path comprises a recirculation loop such that the bolus of fluid flows through the recirculation loop during the phase of the CIP process; and
the controller is configured to:
continuously determine the turbidity of the fluid using the first turbidity sensor to determine a first continuous measured turbidity signal; and
continuously determine the turbidity of the fluid using the second turbidity sensor to determine a second continuous measured turbidity signal.

28. The system of claim 27, wherein:
the controller is configured to calculate a turbidity difference signal, the turbidity difference signal comprising a difference between the first continuous measured turbidity signal and a temporally offset second continuous measured turbidity signal, the temporally offset second continuous measured turbidity signal comprising the second continuous turbidity signal temporally offset by the amount of time it takes for the bolus of the fluid to travel through the fluid path between the first position and the second position; and wherein
determining the end of the phase of the CIP process based on the first measured turbidity and the second measured turbidity comprises determining the end of the phase of the CIP process based on the turbidity difference signal.

29. The system of claim 28, wherein determining the end of the phase of the CIP process based on the turbidity difference signal comprises determining the phase of the CIP process has ended if the turbidity difference signal is less than a predetermined difference threshold for a predetermined period of time.

30. The system of claim 22, wherein the controller is further configured to:
determine a difference between the first measured turbidity and the second measured turbidity;
if the difference between the first measured turbidity and the second measured turbidity meets a predetermined difference threshold, determine the end of the phase of the CIP process has occurred.

31. The system of claim 30, wherein the controller is further configured to, if the difference between the first measure turbidity and the second measured turbidity does not meet the predetermined difference threshold:
determine a third measured turbidity of the bolus of the fluid representing the turbidity of the bolus of the fluid at a third time, wherein the bolus of the fluid travels through the industrial equipment between the second time and the third time;
determine a difference between the second measured turbidity and the third measured turbidity;
if the difference between the second measured turbidity and the third measured turbidity meets the predetermined difference threshold, determine the end of the phase of the CIP process has occurred.

32. The system of claim 22, wherein the controller is configured to:
acquire turbidity data over a period of time, the period of time comprising the first time and the second time;
fit the acquired turbidity data over the period of time to a turbidity data model; and
determine the end of the phase of the CIP process based on the turbidity data model.

33. The system of claim 22, wherein:
the controller is configured to acquire turbidity data over a period of time, the period of time comprising the first time and the second time; and
determining the end of the phase of the CIP process based on the first measured turbidity and the second measured turbidity comprises:
determining a time rate of change of the turbidity data; and
if the time rate of change of the turbidity data meets a predetermined turbidity rate of change threshold condition, determining the end of the CIP process has occurred.

34. The system of claim 22, wherein the phase of the CIP process comprises an alkaline circulation phase.

35. The system of claim 22, wherein determining the end of the phase of the CIP process based on the first measured turbidity and the second measured turbidity comprises predicting a future endpoint of the phase of the CIP process based on the first measured turbidity and the second measured turbidity.

36. The system of claim 22, wherein the industrial equipment comprises one or more of a heat exchanger, a tank, a pipe, a filter, and a valve.

37. The system of claim 22, wherein the controller is configured to at least one of adjusting a rate at which the fluid is directed through the industrial equipment, stop a flow of the fluid through the industrial equipment, and adjust a chemical composition of the fluid.

38. The system of claim 37, wherein:
the phase of the CIP process is a cleaning phase; and
the controller is configured to terminate the cleaning phase and initiate a rinse phase.

39. The system of claim 37, further comprising one or more valves positioned in the fluid path, wherein:
the controller is in communication with the one or more valves and is configured to electronically control fluid flow through the one or more valves; and
the controller is configured to control the CIP process by opening and/or closing at least one of the one or more valves.

40. The system of claim 22, wherein the bolus of the fluid comprises a volume of fluid that flows through a predetermined length of the fluid path in a predetermined amount of time.

41. The system of claim 22, wherein the controller is configured to determine the end of the phase of a CIP process based on the first measured turbidity and the second measured turbidity using a cloud-based computing platform.
